(19) United States
(12) Patent Application Publication
(10) Pub. No.: US 2002/0147616 A1
(43) Pub. Date: Oct. 10, 2002

(54) Method and apparatus for introducing medical necessity policy into the clinical decision making process at the point of care

(75) Inventors: Daniel Lyon Pollard, Durham, NC (US); Peter Franklin Hebert JR., Durham, NC (US)

Correspondence Address: DANIELS & DANIELS, P.A., SUITE 200, GENERATION PLAZA, 1822 N.C. HIGHWAY 54, EAST, DURHAM, NC, 27713, US

(73) Assignee: MDeverywhere, Inc., Durham, NC

(21) Appl. No.: 10/116,919

(22) Filed: Apr. 5, 2002

Related U.S. Application Data
(60) Provisional application No. 60/281,666, filed on Apr. 5, 2001.

(51) Int. Cl. G06F 17/60

(52) U.S. Cl. 705/3

(57) ABSTRACT

A handheld device, such as a personal digital assistant (“PDA”), can be used at the point-of-care to find an appropriate pair of diagnosis code and procedure code for use in writing an order for further medical procedures for a particular patient. The choice of diagnosis code and procedure code can be checked for conformance with the requirements set forth in a particular set of medical necessity policy rules. In a preferred embodiment, the codes and rules are aggregated by medical specialty so that a specialist can work with solely those codes and rules that are relevant to that particular medical specialty. This abstract is provided as a tool for those searching for patents, and not as a limitation on the scope of the claims.

This application claims priority to co-pending U.S. Provisional Patent Application Serial No. 60/281,666 filed Apr. 5, 2001.

This application is assigned to MDeverywhere, Inc. A co-pending application also assigned to MDeverywhere, Inc. is U.S. patent application Serial No. 09/827,812 for Automated Sample Tracking and Generation of Corresponding Prescription. This co-pending application describes other utilities for healthcare service providers that can be implemented on a handheld device.

### BACKGROUND

This invention is useful in the field of medical information management.

Assignee of this invention provides healthcare institutions with physician designated point-of-care solutions that improve information flow, quality of patient care, and improve cash flow for the healthcare institutions. The emphasis is balancing the time available by a physician to gather information to the need to have clinical information. Thus, there is a general goal to simplify and minimize the input by the healthcare provider to collect only the most critical charge capture and documentation elements necessary to provide patient care and to document the visit for billing purposes.

One part of the system is implemented on a mobile device such as a personal digital assistant (PDA) carried by the physician or other health care provider. The health care provider enters diagnostic and procedural information as the provider moves from patient to patient. The information entered into the PDA is then communicated to other portions of the system.

### Medical Necessity Policies

Medical care is expensive and difficult to budget, as it is difficult to forecast when a person is going to get sick or injured. Most recipients of medical care have private or governmental insurance to defray all or some of the cost of medical expenses. The third party payors require information in order to process a claim for payment. Some third party payors, including government programs such as Medicare Part A, Medicare Part B and Medicaid, have limits on what medical services are eligible for reimbursement. A part of the limitation of eligibility for payment is a limitation that only certain tests or other services are medically necessary for certain medical conditions. Such policy is commonly referred to as Medical Necessity policy or Local Medical Review Policy (LMRP). Within this patent, the term Medical Necessity policy is extended to include the internal policies within an organization such as a health maintenance organization (“HMO”) that seek to limit medical procedures to situations where the diagnosis code indicates a medical necessity.

To facilitate the use of computers and to have a widely accepted shorthand, the medical services are codified using code sets such as CPT™ (Current Procedural Terminology) published by the American Medical Association (AMA) and HCPCS (HCFA Common Procedure Coding System) published by the Health Care Financing Administration (HCFA), ADA published by the American Dental Association and DMERC (Durable Medical Equipment Regional Carriers) published by HCFA. As used within this patent and the claims that follow the term procedure is used broadly to include a wide range of medical services including tests, examinations, and other procedures such as surgery or setting a broken bone. Likewise, diagnoses are codified using code sets such as ICD-9-CM (International Classification of Disease, 9^{th} Revision, Clinical Modification), DRG (Diagnosis Related Groups) published by HCFA, DSM IV (Diagnostic and Statistical Manual of Mental Disorders, Fourth Edition) published by the American Psychiatric Association.

When filing claims for medical services, healthcare providers must submit one or more diagnosis codes along with each procedure code for which the healthcare provider is seeking reimbursement. Submitted diagnosis and procedure codes must be substantiated by the patient's medical record. Payment of the submitted claims can be denied if the claim fails the payor's medical necessity test. Conceptually this makes sense, but the implementation of this concept puts a great burden on clinicians who are ordering and performing medical services.

### Prior Art Method

FIG. 1 shows the relationship between CPT codes and ICD-9-CM codes in a partial representation of combinations of procedures eligible that satisfy a medical necessity test. More specifically, FIG. 1 is an example of a partial list of ICD-9-CM codes that satisfy Medical Necessity policy for CPT codes 92226 (Ophthalmoscopy, extended, with retinal drawing, with interpretation and report, subsequent) and 92240 (Indocyanine-green angiography with interpretation and report) as defined by the Medicare Part B Payor in the state of North Carolina. Note that there may be additional medical necessity criteria not represented in FIG. 1 such as a prohibition from repeating an x-ray procedure within a certain time period of taking an x-ray for a given condition.

The point to be absorbed is that FIG. 1 illustrates a small portion of a complex many to many relationship. In many cases the Medical Necessity policy is established by the state fiscal intermediaries and carriers and therefore the specific content varies from state to state. For example, Nebraska Medicare has medical necessity policies that include over 490,000 pairs of CPT and ICD-9-CM codes, while North Carolina Medicare has medical necessity policy set that includes only 350,000 pairs of CPT and ICD-9-CM codes. Thus, a physician moving from Nebraska to a practice in North Carolina is likely to continue to use one or more pairs of diagnosis/procedure codes that was appropriate in Nebraska but was one of the 140,000 pairs of codes not included in the North Carolina medical necessity policy set.

To make the situation more complicated, there is a constant evolution of the CPT codes to add new medical procedures. Likewise, the ICD-9-CM codes continued to be refined. In addition to the changes precipitated by the updates to the CPT and ICD-9-CM codes, there are additional changes to the each payors' Medical Necessity policy as each payor comes to new opinions on which diagnoses support the medical necessity of a given procedure. Thus, a pair of ICD-9-CM diagnosis and CPT procedure codes that was eligible for reimbursement one month may become ineligible the next month. To illustrate the complexities of the system, for one set of medical necessity policies, a cardiologist ordering a heart catheterization would need to know that the diagnosis code for “angina pectoris” (diagnosis code 413.9) is not listed in the particular medical necessity policy for authorization for payment for a particular type of heart catheterization (procedure code 93501). However a diagnosis code for the more general condition of chest pain (diagnosis code 786.50) is a suitable for justifying a heart catheterization under this set of Medical Necessity Policy rules. With so many codes and policies, there is a need for a tool to identify traps for the unwary that lead to refusals to pay for legitimate and necessary medical procedures.

Against this factual backdrop, it is useful to examine the typical process for ordering a medical service such as a blood test at a laboratory. FIG. 2 has the following steps.

Step 210. Clinical Decision Making Process during the Patient Encounter. A physician interacts with a patient. This may happen in a hospital or in a medical clinic. During the encounter, the physician often reviews the patient's history, performs physical examinations and other evaluations, applies clinical knowledge to assess the situation and determines a plan of treatment. This complex process is the Clinical Decision Making Process. Traditionally, this process is driven based on medical and legal principles and practices.

Step 220. Order the Test or Procedure. After the physician determines the plan of treatment, the physician will order the particular test or procedure that would be clinically beneficial to the patient. Orders are generally conveyed using non-computerized mechanisms such as writing the order in the chart, checking a box on an encounter form or speaking a verbal order to a nurse or other ancillary clinical staff (who in turn writes it in the chart or on the encounter form). If the physician indicates a diagnosis along with the order it is generally in free form and not codified in a diagnosis coding system such as ICD-9-CM.

While the physician learns through years of medical training and experience the interactions between the various diagnostic conditions and when it is prudent to order tests to rule out certain conditions, it is not part of the physicians training to see the world through the eyes of the third party payors and their explicit rules for Medical Necessity. Thus, the physician often fails to fully capture the relevant diagnostic situation with respect to appropriate Medical Necessity policy.

Step 224. Enter Order onto a Paper Order Form. To process the order, a specific order form must be completed. Depending upon the performing lab or the type of procedure, a different order form will need to be completed. Such forms are often complex requiring coded diagnoses and other pertinent information. A clerk or other clerical staff will take the paper record of the order from step 220 and complete an appropriate order form. There is often a time lag between the time when the order is given and the time the order form is completed. Therefore, in time critical situations, the ordering physician may fill out the form themselves, but this is the exception.

Step 226. (optional) Enter Order into a Computerized Order Entry System. Instead of completing a paper order form, many hospitals and clinics have a computerized order entry system. Such systems are used by clerks or other clerical staff electronically capture enter the order from Step 220. There is often a significant time lag between the time that the physician gives the order and the time a clerk enters the order into the order entry system. Advanced order entry systems may have the capability to check the medical necessity of the order, but many of them do not. Such a Medical Necessity Checkpoint is described in Step 260.

More recent order entry systems include systems designed to be used by a physician, however, these systems are not on handheld devices and thus typically require the caregiver to either leave the patient to enter the order or turn away from the patient in order to enter the order on a desktop machine in the examination room. Thus, order entry systems or the emerging field of electronic medical record systems (EMR systems) do not offer the advantages of the present invention as described below.

Step 230. Perform the Lab Test or other Procedure. After the paper order form is complete (or the order has been entered into an order entry system), it is submitted to the entity that will complete the order. Examples of these entities include a laboratory, a radiology group, a scheduling clerk or a nurse. This entity is obligated to perform the order as described by the ordering physician. In cases where there is a problem with the order, the order may be delayed to seek clarification.

It should be noted that in certain cases, the entire ordering process is bypassed and instead of ordering another group to perform the lab test or procedure, the physician performs the lab or procedure himself or herself. This is represented in FIG. 2 by the line from step 210 to step 230. An example of such a case may be an ECG or an in-office procedure.

Step 240. Document Performed Test or other Procedure. If the physician performs a lab test or Procedure, they are generally documented using non-computerized mechanisms such as writing in the chart, checking a box on an encounter form or dictating a note. If a diagnosis is indicated along with the Lab Test or other Procedure it is generally in free form and not codified by a diagnosis coding system such as ICD-9-CM.

If another group performs the lab test or procedure, there is a greater chance that an automated system will be used to document the lab test or other procedure. For example, a laboratory will often enter the diagnostic ICD-9-CM codes and the requested test CPT codes into a Laboratory Information System (LIS) before performing the test. Advanced LISs may have the capability to check the Medical Necessity of the order. Such a Medical Necessity Checkpoint is described in Step 260.

Step 250. Bill for the Test or other Procedure. After a significant lag in time, a clerk or other clerical staff will take the documentation of the performed test or procedure and enter it into a billing, a claim scrubbing or a claim editing system. Advanced systems may have the capability to check the medical necessity of the test or other procedure. Since the test or procedure has already been performed, the resources required to perform the service have been spent. This issue now becomes how much money can be obtained through reimbursement for the provision of the service.

It is at this point that the vast majority of Medical Necessity problems are identified. Most of these services are never billed and are written-off because it is too late in the process to remedy them. Such a Medical Necessity Checkpoint is described in Step 260.

Step 260. Medical Necessity Checkpoint. At any point where the test or other procedure is entered into system, an advanced system will check it for Medical Necessity. The places identified in the above process where Medical Necessity can be checked include: 226: Order Entry System, 240: Laboratory Information System, 250: Billing System, Claims Scrubbing Systems. The critical flaw of a medical necessity check at any of these points in the process is that the ordering/performing physician is separated from the results of the check by time and distance. Furthermore, the individual who receives the alert can do little to effectively remedy the problem.

When a Medical Necessity alert is given to staff other than the ordering/performing physician, a limited set of options are available. To make the problem less abstract, assume that a blood lab has detected a problem with the Medical Necessity approval for a requested blood test, before the blood lab conducts the test. There are three options.

A) Seek Physician Clarification. The staff can attempt to contact the physician directly or indirectly through the physician's staff. The blood lab can report that the requested test fails a medical necessity test and ask for the physician to evaluate whether a diagnostic code was omitted or whether a more precise diagnostic code is appropriate. Sometimes the problem is corrected when a more specific diagnostic code is provided. Alternatively the problem can be solved by altering the choice of blood tests, such as ordering a partial panel of tests rather than a full panel of tests. This is not an option unless the blood lab noted the problem with Medical Necessity policy before performing the blood tests. This choice has several negative ramifications. One is that a large amount of time must be expended by the blood lab staff and by the physician to refine the combination of codes. Many physicians, especially specialists in a hospital setting, see a great number of patients with similar medical conditions. Thus, a request to refine the combination of codes on a request for blood work may require retrieval of the medical chart from storage or another part of the hospital. It may well take as long for a physician to review a file and determine whether another pair of diagnosis/CPT codes is appropriate as it took for the physician to interact with the patient the first time. The time spent to correct the paperwork to meet the Medical Necessity requirements would not be billable for either the physician or the blood lab. There is a second problem. The blood samples deteriorate over time and after some level of delay, the sample must be discarded and new blood drawn. There is a third problem. Sometimes there is an urgent need to receive medical results from a lab test to confirm or rule out one condition so that the physician can order drugs, treatment, or other tests. Delays in getting appropriate codes to the lab can delay the return of results to the physician and can reduce the quality of healthcare that is provided to the patient.

B) Perform Test and Risk Non-payment. The second option is to perform the test without appropriate codes to pass the medical necessity screening. For the reasons set forth above, there is a time pressure to get results back to the physician. Blood labs compete with one another to provide services to physicians working outside of a hospital so that blood lab does not want to irritate a physician and cause the physician to send future work to another blood lab. Blood labs within a hospital may have concerns that a delay in getting paperwork regarding billing details may not justify delaying a blood test that is urgently needed for a patient with an acute condition. The blood lab can seek to get the correct codes after the blood work is done if this is allowed by the third party payor. For a hospital, the cost of correcting the paperwork may be larger than the cost of the test so it may simply go as unbilled. With a blood lab servicing physician offices, the blood lab can simply not bill for reimbursement, bill the physician who ordered the un-reimbursable test, or bill the patient for the full amount of the test. Note, that some third party payors such as Medicare prohibit billing a patient for charges for which Medicare has denied payment.

C) Perform Test but Change Diagnostic Codes and Risk Fraud. The third option is for the blood lab staff to simply change the set of diagnostic codes to include one or more codes that would justify the blood test that is failing the medical necessity test. While this would get the request for a blood test through the process, it is not a valid option. Only the physician may order medical services and diagnose the patient. Adding codes to the order to get it through the medical necessity process would be deemed fraud. If the fraud caused payment by a government program such a Medicare, then the fraud would be subject to severe penalties.

### Problems with the Prior Art Solutions

Surprisingly the current situation has been a problem for a number of years. The requirement that a medical service be approved as a medical necessity for a given diagnostic condition has existed for many years. Examples of the legal requirements for submission of requests for payment include:

1. Title XVIII of the Social Security Act, Section 1862 (a) (1) (A). This section allows coverage and payment for only those services that are considered to be medically reasonable and necessary;

2. Title XVIII of the Social Security Act, Section 1833 (e). This section prohibits Medicare payment for any claim that lacks the necessary information to process the claim; and.

3. Section 4101 of the Balanced Budget Act (BBA) of 1997.

Previous attempts to solve the Medical Necessity issue have focused on the wrong parts of the order process. Attempts to bring the physician into the process have failed. One suggested solution is to have physicians use fixed computer workstations to place orders for tests. This solution ignores the reality that physicians move from room to room to meet with patients and prefer to face the patient rather than a computer terminal when working with a patient. This solution also misjudges the complexity of clinical data and the difficulty of entering such data into a computer system. Current processes requiring time intensive processes to log into the system, extensive training, for use on a fixed workstation are too tedious for use during the medical decision making process.

Sometimes all that is necessary is some additional precision in selecting from a myriad of codes so that information that the service provider believes is obvious from context gets recorded into the system. For example a terse handwritten description leaves ambiguity and thus fails to precisely communicate the patient's diagnosis for accurate billing. For example, while a user may think writing “Anemia” on an order or billing form is adequate, a coder must determine which type of anemia to code: 280.0 Anemia iron deficiency-chronic blood loss; 280.1 Anemia iron deficiency-decreased intake; 280.9 Anemia iron deficiency-unspecified; 281.2—Anemia folate deficiency; 281.9—Anemia unspecified deficiency, etc. Using a convenient tool to quickly find the appropriate diagnosis code eliminates this potential for confusion.

The longstanding need to reduce the amount of requests for medical services without a suitable pair of CPT/ICD-9-CM codes might cause one to infer that the problem is relatively small and would not justify much effort to solve it. However, the financial magnitude of this problem is actually extremely large and significant. While it is probably not possible to accurately measure the non-billable time spent correcting unsuitable requests for medical services, or the amount of money spent by patients because improper coding pairs prevented them from receiving payment from their insurance companies, it is possible to measure the amount of medical services performed at a hospital that could not be submitted for reimbursement. The write-offs associated with just Medical Necessity denials can exceed several million dollars a year at a large hospital. One estimate of the costs to rework an order for medical services when the violation of the Medical Necessity Policy rule set is not caught at the patient encounter is $25 per error.

It is thus an object of the present invention to provide a handheld tool to a healthcare provider to allow orders for medical procedures to be written with procedure code/diagnosis code pairs that satisfy a medical necessity policy rule.

It is another object of the present invention to provide a handheld tool to a healthcare provider to modify an initial procedure code/diagnosis code pair to a pair that satisfies a medical necessity policy rule.

It is still another object of the present invention to provide a handheld tool to a healthcare provider that can be used in conjunction with an electronic medical records system to allow the selection of a procedure code/diagnosis code that satisfies a relevant medical necessity policy rule and to electronically convey this information to the electronic medical records system.

It is yet another object of the present invention to facilitate the speedy selection of appropriate codes by a healthcare provider by allowing the healthcare provider to load healthcare specialty files into the handheld tool so that only the procedure codes, diagnosis codes, and medical necessity policy rules likely to be routinely used by providers of a particular healthcare specialty are loaded onto the handheld tool.

These and other objects of the present invention are achieved by the invention as described in the specification and related figures.

### BRIEF SUMMARY OF THE DISCLOSURE

The solution is to provide a medical necessity reference tool as a software application that can be delivered on a handheld device carried by the physician as the physician goes about the practice in interacting with patients. Ideally, the handheld device is sized to fit within one of the pockets on a physician's lab coat. In one disclosed embodiment, the software on the handheld device provides a set of ICD-9-CM (diagnosis codes) and CPT codes (procedure codes) for a given specialty. Since an orthopedist would not order certain obstetrical procedures for a patient and an obstetrician does not order a spine fusion procedure for the obstetrician's patient, a full set of pairs of approved combinations of ICD-9-CM and CPT codes does not need to be available to each physician.

Within the subset of information provided for a particular medical specialty, the physician can find the desired CPT procedure code or ICD-9-CM diagnosis codes for that specialty. A bullet next to the code indicates that a Medical Necessity policy exists for that code.

This specification teaches a method of preparing an order for medical services. In general terms one variation of the method encompasses downloading electronic information into a handheld device with diagnosis codes, procedure codes, and at least one set of medical necessity policy rules. While working with the patient, the healthcare provider checks the initial pair of codes that the provider plans to use for writing a medical order for medical services. The healthcare provider can check to make sure that the pair of codes works is an authorized pair under the relevant set of medical necessity policy rules. If the pair is not authorized, the healthcare provider can work with either the diagnosis code or the procedure code to find an appropriate corresponding code to authorize the chosen medical procedure.

### BRIEF DESCRIPTION OF THE DRAWINGS

FIG. 1 helps illustrate the environment for the present invention by showing the relationship between CPT codes and ICD-9-CM codes in a partial representation of the many to many relationship of procedures eligible that satisfy a medical necessity test.

FIG. 2 illustrates the typical process of ordering a medical service such as a blood test at a laboratory under the prior art system.

FIG. 3 shows the revised flowchart for the process listed in FIG. 2 in order to illustrate one implementation of the present invention.

FIGS. 4-9 are examples of screenshots of one implementation of the present invention on a PDA.

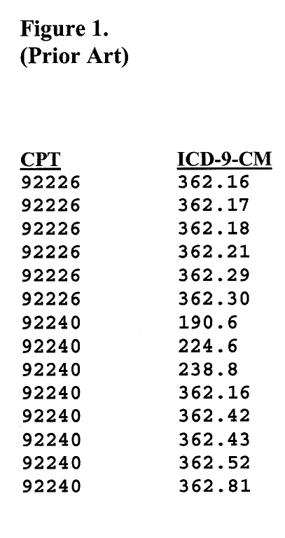

### DETAILED DESCRIPTION OF THE DISCLOSED EMBODIMENT

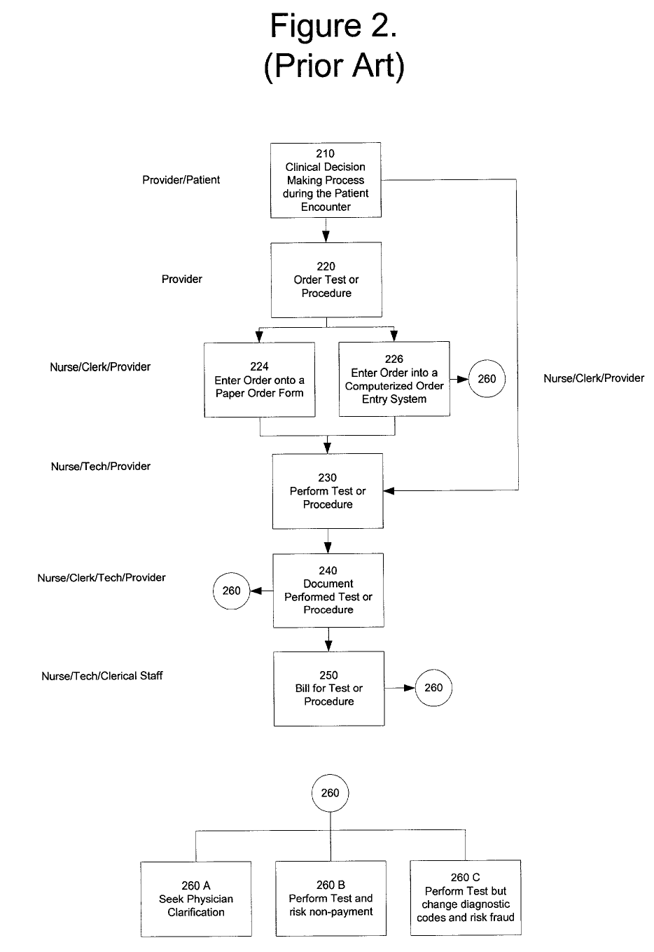

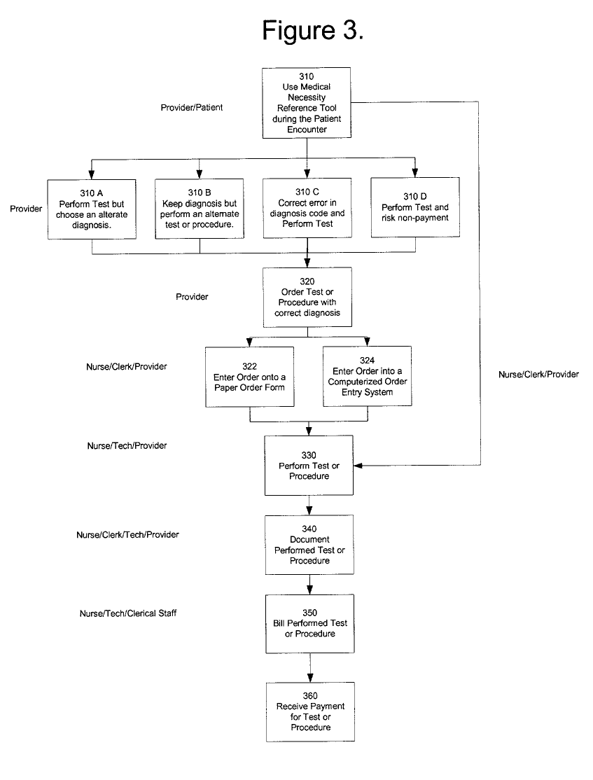

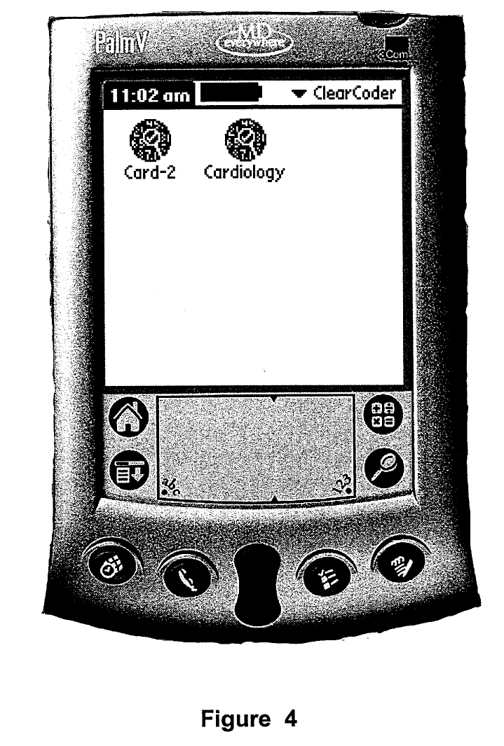

FIG. 3 shows the revised flowchart for the process listed in FIG. 2. FIG. 3 shows the process as modified by one implementation of the present invention.

Note, that in order to promote clarity in the description, common terminology for components is used. The use of a specific term for a component suitable for carrying out some purpose within the disclosed invention should be construed as including all technical equivalents which operate to achieve the same purpose, whether or not the internal operation of the named component and the alternative component use the same principles. The use of such specificity to provide clarity should not be misconstrued as limiting the scope of the disclosure to the named component unless the limitation is made explicit in the description or the claims that follow.

Step 310. Introduction of medical necessity reference tool application into Clinical Decision Making Process during Patient Encounter. A physician interacts with a patient as described in connection with Step 210. This interaction may happen in a hospital or in a medical clinic. During the Clinical Decision Making Process, the physician determines what he/she feels are clinically necessary lab test and or other procedures. The physician takes a handheld device from the physician's lab coat. The device has the CPT codes and ICD-9-CM codes for the physician's specialty loaded. The physician finds the desired tests and/or procedure as one of the listed CPT codes. The device notes that a Medical Necessity policy applies to the CPT code for this test. The physician asks the device for a list of ICD-9-CM codes that are considered to justify this test. Surprisingly, the ICD-9-CM code that the physician was planning on using to justify the test is not on this list.

In Scenario A, shown in Step 310A, the physician reviews the list of ICD-9-CM codes that satisfy the medical necessity policy for this CPT code and finds that one such ICD-9-CM code is a variant of the ICD-9-CM code that the physician has chosen for this patient. The physician uses this more specific ICD-9-CM code to justify the order for the lab test.

Scenario B in Step 310B. The physician is surprised that the ICD-9-CM code is not on the list of ICD-9-CM codes that justify this lab test. The physician receives quite a stack of reading material every month. The physician receives but does not routinely read the notices that change in LMRPs have reduced the number of ICD-9-CM codes that can be used to justify this broad lab panel. The physician decides to check to see if another lab panel, perhaps a less expensive test that checks for fewer attributes is justified. The physician could scroll through the lab panel tests and select a narrower one then check to see if it would be justified by the ICD-9-CM code. However, the physician decides to go at this problem the opposite way. The physician goes to the ICD-9-CM list for the physician's specialty and picks the ICD-9-CM code that the physician believes best describes the patient's condition. Upon request, the device provides a list of all CPT codes for procedures that are supported by this ICD-9-CM under the LMRP. This method quickly leads the physician to an alternate lab panel that will be sufficient for the physician's need for information. The physician retains the original ICD-9-CM code and adopts the new CPT code for the less expensive test.

Scenario C in Step 310C. A Family Practice physician sees a patient that presents with pneumonia symptoms. The physician decides to order a chest x-ray to confirm the diagnosis. The physician uses the medical necessity reference tool application to checks to see that the CPT code for the chest x-ray lists the ICD-9-CM code for possible pneumonia as an ICD-9-CM code that justifies the chest x-ray. The physician also requests a thyroid function panel to rule out possible a possible diagnosis of hyperthyroid. When the physician starts to write out the order for a blood panel to check thyroid performance and then looks for the ICD-9-CM code in the mind of the physician, the code is not listed as one that satisfies the medical necessity criteria for the thyroid panel. The physician wonders why, and then realizes that the physician was still thinking of the ICD-9-CM code for the possible pneumonia. The physician catches this error and correctly files out the request for the thyroid panel using the ICD-9-CM code for possible hyperthyroidism.

Scenario D in Step 310D. The doctor disagrees with the medical necessity policy and continues to order the lab test or procedure with the non-covered diagnosis. The physician proceeds risking non-payment. To reduce the risk of non-payment, the physician can have the patient complete an advanced beneficiary notice (ABN). This waiver allows the physician to bill a patient for a “non-medically necessary” service.

Step 320. Order the Lab Test or other Procedure. After the physician determines that a particular lab test or procedure would be clinically beneficial to the patient, the physician will order the test. Orders are generally conveyed using non-computerized mechanisms such as writing the order in the chart, checking a box on an encounter form or speaking a verbal order to a nurse or other ancillary clinical staff (who in turn writes it in the chart or on the encounter form). The physician documents with the order a clinically appropriate ICD-9-CM diagnosis code that also justifies Medical Necessity (unless acting under option 310D discussed above.)

Steps 322/324. Enter Order. When the order form is completed (or the order is entered into an order entry system), a valid ICD-9-CM diagnosis code will be included. The physician has caught and corrected an error with the pairing of CPT and ICD-9-CM codes so as to greatly reduce the likelihood that the payor will deny payment based on medical necessity. There is still the possibility that the codes will be written/entered incorrectly or illegibly, but these errors existed under the old system and are not increased by the use of the present invention.

Step 330. Perform Test or other Procedure. The test or procedure is performed with confidence that it will be reimbursed. Often the lab will enter the diagnostic codes and the requested test CPT code into a computer before doing a test. While the lab may stop this pre-check if the physicians rarely submit an invalid combination of payor, CPT and ICD-9-CM codes, the more likely scenario is that the lab will continue to check. The lab may support some physicians in medical practices that do not use the present invention. Large hospitals with many different physicians may have one or more physician that does not use the present invention and instead relies on the memory of the physician.

Step 340. Document Test or other Procedure. The test or procedure is documented with the appropriate, medically necessary diagnosis code.

Step 350. Bill for Test or other Procedure. The test or other procedure is then entered into the billing system and billed with minimal medical necessity issues.

Step 360. Receive Payment. Payment is received for the test or other procedure.

One preferred embodiment of the present invention is a Palm Pilot application targeted at physicians and administrators who are interested in coding and reimbursement. The application is referenced throughout this document as ClearCoder, which is a trademark for one implementation of the present invention.

In the preferred embodiment the extensive list of ICD-9-CM diagnostic codes and CPT procedure codes is broken into subsets. A separate module is available for each specialty and includes only relevant diagnosis, procedure codes and the relevant set of rules under a particular Medical Necessity policy. Including only relevant codes for a specialty simplifies the task of finding an appropriate code. Under the current implementation, up to 8 specialty modules can be present on a single Palm Pilot. ICD-9-CM diagnosis codes and CPT procedure codes are divided into logical categories to assist code browsing. Text or code lookup, search and sorting can be done within each category or across all codes. Clicking on a procedure code displays diagnoses that are accepted by appropriate medical necessity policy. Clicking on a diagnosis code displays the procedures that can be done under such diagnosis under the local medical review policy.

Here is how the specialty file is created and loaded.

1. Create a separate downloadable .prc file for each specialty. A .prc file is a standard file type for Palm applications.

Users who want multiple specialties on their handheld will need to download multiple .prc files.

All specialty .prc files will be added to a program group called “ClearCoder”

2. Use specialty specific ICD-9-CM and CPT codes for a variety of specialties. Approximately 2000 ICD-9-CM codes and 300 CPT codes are available for each specialty.

3. Use appropriate Medical Necessity policy. The Medical Necessity policies include: the appropriate state specific policy for Medicare or Medicaid: a policy such as the authorization policy for a third party payor; or the internal policy for an HMO.

4. For a given specialty, limit Medical Necessity data to the CPT codes present in each specialty list. If possible, include all diagnoses listed in the Medical Necessity policy An example of the process to select ICD-9-CM and CPT codes for a specialty is as follows:

Step one: pick your specialty or subspecialty to be the subject for the selection of ICD-9-CM and CPT codes.

Step two: pick all of the CPT codes normally associated with that specialty including some general codes that would apply to that specialty and to others.

Step three: pick all of the ICD-9-CM codes routinely associated with that specialty and the general ICD-9-CM codes that would be useful to a specialist.

Step four: identify all of the Medical Necessities policies that apply to any CPT code listed in step two.

Step five: for each CPT code show the diagnoses that are in the both the Medical Necessities policies and in the specialty set of diagnosis codes. Thus, a procedure such as a chest x-ray would only list diagnoses that would be relevant to this specialty and not a myriad of other diagnoses.

Here is how the handheld device is used.

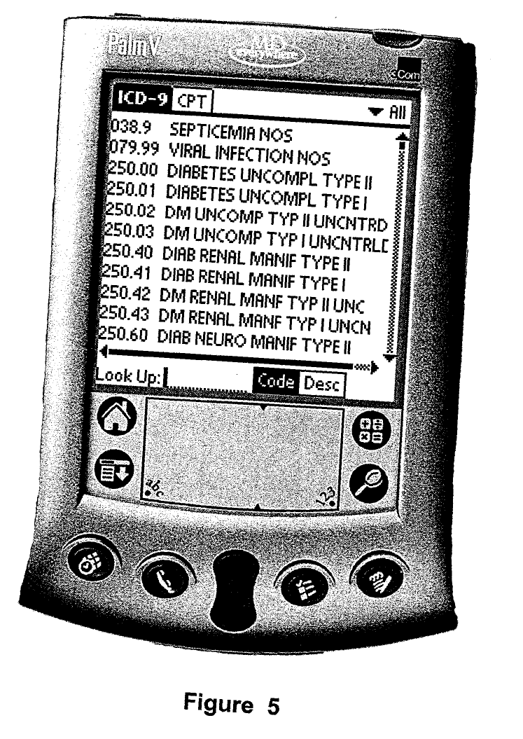

1. Begin search by choosing the CPT tab for procedures or the ICD-9-CM tab for diagnoses. (See example of screenshot in FIG. 5)

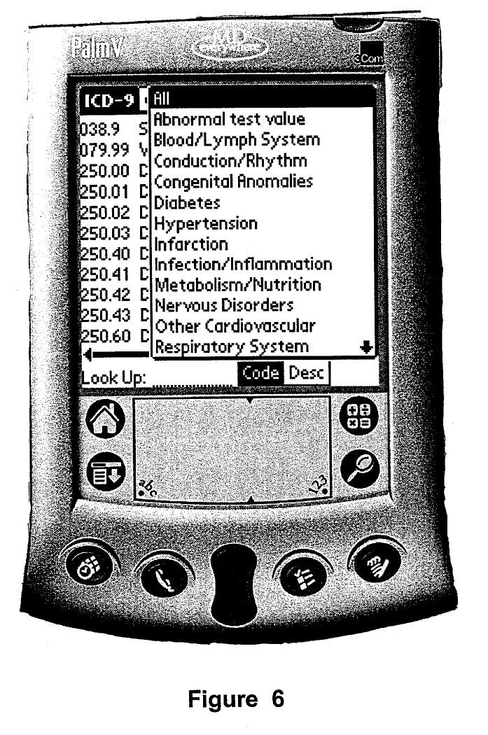

2. Find a diagnosis (or procedure) by Category or by All. Within a category or All, be able to sort and look-up a diagnosis (or procedure) by code or by description. (See example of a screenshot in FIG. 6)

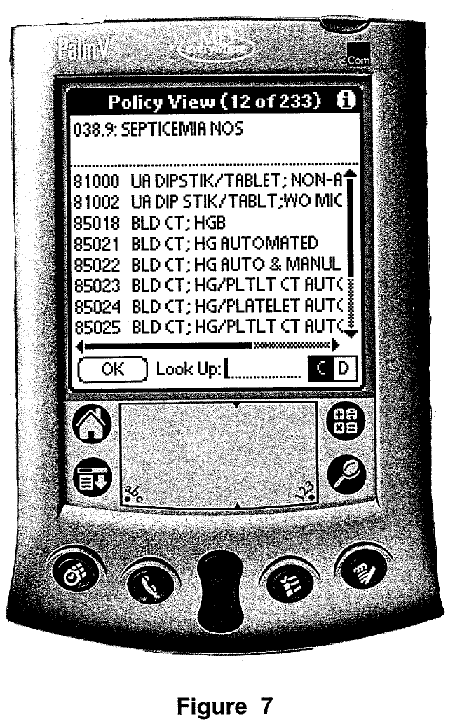

3. Tapping on a diagnosis (or procedure) with a bullet next to it will display the Policy View screen if Medical Necessity policy exists. (See example screenshot in FIG. 7)

The Policy View screen shows all of the procedures for a given diagnoses (or diagnoses for a given procedure) that are on the device and are valid according to the set of rules for the relevant Medical Necessity Policy. The Policy View displays both the code and the description. Preferably, the Policy View mode contains both Look up and search functionality. Preferably, the Policy View mode provides the ability to sort by code or by description.

Clicking on a diagnosis (or procedure) will display the policy of the selected diagnosis (or procedure) in a new Policy View screen.

4. Tapping on a diagnosis (or procedure) without a bullet next to it will display an alert that no Medical Necessity policy exists for the select diagnosis (or procedure).

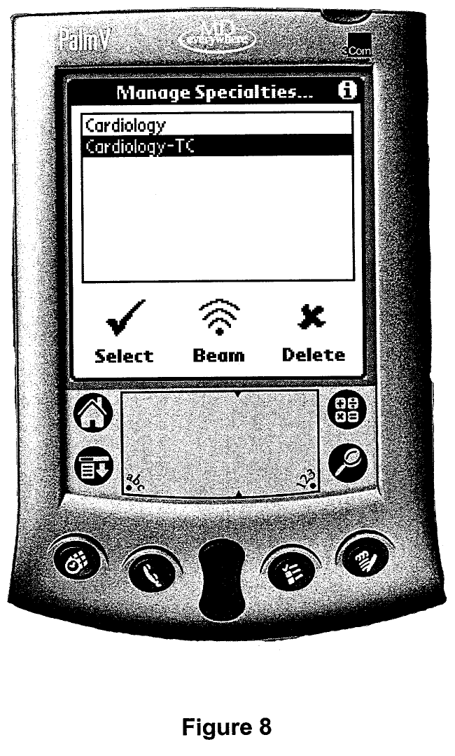

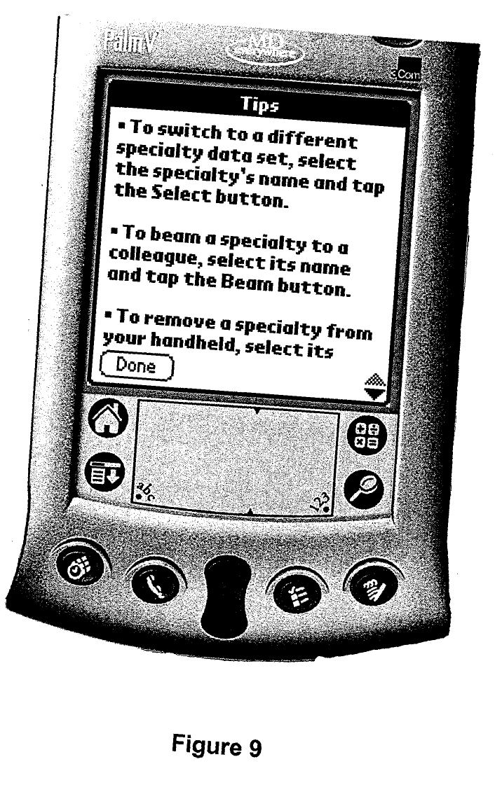

5. For users who have loaded more than 1 specialty on their handheld, they have a tool to easily manage the specialties. (See examples of a screenshots in FIG. 8 and 9) The user is able to switch to a different specialty (Select), Beam a specialty to another user (Beam), and Delete a specialty they no longer want on their device (Delete). Tapping on the (i) takes the user to a Tips screen.

### Variations and Embellishments

While the above description repeatedly refers to the physician, this invention can be used by other caregivers or by a clerical assistant to the physician. So in addition to specialist MDs, Primary Care MDs, and residents, the invention can be used by billing clinicians, nurses, coders and clerical staff where appropriate.

The preferred embodiment of the present invention uses the various tools associated with a PDA to download the application and updates to the application. With the growth of wireless communication links within medical facilities, the present invention could be implemented to provide the same functionality to the physician but without a full download of the relevant data or application onto the device carried by the physician. While the preferred embodiment uses the Palm device and operating system, other platforms can be used to implement all or the majority of the features described above. Examples include, but are not limited to, handheld computing devices running operating systems, such as Palm OS, Windows CE, E-book, RIM pager, EPOC, or LINUX.

While the preferred embodiment creates clusters of procedures and diagnostic codes relevant to a particular specialty and allows one or more sets of codes to be loaded for one or more specialties, this is not a requirement for the invention. An alternative embodiment would allow the physician to access the complete set of ICD-9-CM codes and CPT codes. The physician would then use a search feature to narrow the set of codes to one that is small enough to browse.

In order to give examples that would be meaningful to those of skill in the art, this specification uses the ICD-9-CM and CPT codes. It is recognized that the invention is not limited to systems that use these particular sets of codes or to the other code sets provided as examples within this specification. Any system of patient diagnostic codes and medical service codes would be sufficient. Note further, that although the examples in this patent used CPT codes and ICD-9-CM codes which are typically used by physicians, the current invention can be used by psychologists, dentists, visiting nurses, physical therapists, chiropractors, podiatrists, or other healthcare services providers with the relevant diagnosis and medical service codes.

The examples given use the medical service of a blood test. The range of medical services that could be covered by this invention is not limited to blood tests. For example, and without limitation, the services could be medical procedures including surgical procedures, diagnostic procedures, lab tests, medications, durable medical equipment, dental services, physical therapy, or psychological services.

The examples given throughout this specification are based on government programs as third party payors. Note that the invention disclosed above can be adapted to implement private heuristics on medical necessity so that a large hospital or an HMO can communicate a unified set of rules concerning the medical necessity of certain procedures with respect to various diagnostic codes.

An alternative embodiment of the disclosed invention calls for use of the present invention within the context of a handheld system for electronic medical record systems. In such an implementation the entry of an order into the electronic medical record system would identify diagnosis pair/procedure code pairs that would not satisfy any relevant medical necessity policy rule. Early identification and modification to the code choices would afford the benefits listed above and would be incorporated into patient's medical records. The order for the procedure matching the procedure code could be electronically generated and thus avoid any error introduced by handwritten orders. The order could be conveyed from the handheld device by wireless link to the external electronic medical records system or other relevant computer system. Alternatively, the order could be transferred from the handheld device to another computer system via a docking station.

Those skilled in the art will recognize that the methods and apparatus of the present invention has many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

1. A method of preparing an order for medical services, the method comprising the steps of:
A. downloading electronic information into a handheld device with diagnosis codes, procedure codes, and at least one set of medical necessity policy rules;
B. deciding that a medical procedure with procedure code P1 is necessary based on an initial diagnosis with diagnosis code D1, the decision made during an interaction with a patient by a healthcare provider;
C. accessing (by the healthcare provider during the interaction with the patient) from the handheld device, a list of all diagnosis codes identified in the relevant medical necessity policy rules as sufficient justification for execution of procedure code P1;
D. selecting a diagnosis code D2 to be used for authorization of procedure code P1 instead of initial diagnosis code D1; and
E. communicating the order for future medical services, the order including the diagnosis code D2 and the procedure code P1.

2. The method of preparing an order for medical services of claim 1 wherein the downloaded set of diagnosis codes excludes the majority of available diagnosis codes but contains a sub-set of diagnosis codes associated with a medical service specialty.

3. The method of preparing an order for medical services of claim 1 wherein the downloaded set of procedure codes excludes the majority of available procedure codes but contains a sub-set of procedure codes associated with a medical service specialty.

4. The method of preparing an order for medical services of claim 1 wherein the step of downloading electronic information into a handheld device comprises the sub-steps of:
downloading a first set of electronic information containing a subset of diagnosis codes, a subset of procedure codes, and a subset of medical necessity policy rules, each subset selected in order to facilitate the act of selecting appropriate diagnosis and procedure codes for a first medical service specialty; and
downloading a second set of electronic information containing a subset of diagnosis codes, a subset of procedure codes, and a subset of medical necessity policy rules, each subset selected in order to facilitate the act of selecting appropriate diagnosis and procedure codes for a second medical service specialty;
the method further comprising the step of deleting the first set of electronic information from the handheld device after downloading the second set of electronic information.

5. A method of preparing an order for medical services, the method comprising the steps of:
A. downloading electronic information into a handheld device with diagnosis codes, procedure codes, and at least one set of medical necessity policy rules;
B. deciding that an additional procedure with procedure code P1 is necessary based on an initial diagnosis with diagnosis code D1, the decision made during an interaction with a patient by a healthcare provider;
C. accessing (by the healthcare provider during the interaction with the patient) from the handheld device, a list of all procedure codes identified in the relevant set of medical necessity policy rules as justified based on a diagnosis code of D1;
D. selecting a procedure code P2 instead of the previously chosen procedure code P1; and
E. communicating the order for future medical services, the order including the diagnosis code D1 and the procedure code P2.

6. The method of preparing an order for medical services of claim 5 wherein the downloaded set of diagnosis codes excludes the majority of available diagnosis codes but contains a sub-set of diagnosis codes associated with a medical service specialty.

7. The method of preparing an order for medical services of claim 5 wherein the downloaded set of procedure codes excludes the majority of available procedure codes but contains a sub-set of procedure codes associated with a medical service specialty.

8. A method of preparing an order for medical services, the method comprising the steps of:
A. downloading electronic information into a handheld device with diagnosis codes, procedure codes, and at least one set of medical necessity policy rules;
B. deciding that a medical procedure with procedure code P1 is necessary based on an initial diagnosis with diagnosis code D1, the decision made during an interaction with a patient by a healthcare provider;
C. accessing (by the healthcare provider during the interaction with the patient) from the handheld device, a list of all diagnosis codes identified in the relevant medical necessity policy rules as sufficient justification for execution of procedure code P1;
D. noting that the set of medical necessity policy rules will not authorize payment for procedure P1 based on diagnosis D1;
E. drafting an advanced beneficiary notice (ABN) notifying the patient that the patient may need to pay for the procedure P1 as it will not be eligible for payment when based on diagnosis D1 under the relevant medical necessity policy rules;
F. obtaining the patient's signature on the advanced beneficiary notice as part of preparing the order for procedure P1; and
G. communicating the order for future medical services, the order including the diagnosis code D1 and the procedure code P1.

9. A process for loading a set of medical necessity information for a particular healthcare specialty onto a handheld device for use by a healthcare provider, the process comprising:
A. selecting a healthcare specialty;
B. selecting a set of procedure codes from a first electronic file, the selected set of procedure codes including:
a. those procedure codes associated with the chosen healthcare specialty; and
b. procedure codes commonly used by both the healthcare providers within the chosen healthcare specialty and by other healthcare providers;
C. selecting a set of diagnosis codes from a second electronic file, the selected set of diagnosis codes including:
a. those diagnosis codes associated with the chosen healthcare specialty; and
b. diagnosis codes commonly used by both the healthcare providers within the chosen healthcare specialty and by other healthcare providers;
D. selecting a set of medical necessity policy rules that apply to any of the selected procedure codes from a third electronic file, each medical necessity policy rule containing a procedure code and a list of at least one diagnosis code deemed sufficient to justify execution of that procedure code;
E. identifying each diagnosis code contained within the selected set of medical necessity policy rules that is in the selected set of diagnosis codes; and
F. downloading into the handheld device the selected set of procedure codes, the selected set of diagnosis codes, and the subset of the medical necessity policy rules information containing medical necessity policy rules with one of the selected procedure codes and with at least one of the selected diagnosis codes, but excluding from the downloaded medical necessity policy rules information, any medical diagnosis codes not included in the selected set of diagnosis codes.

10. A mobile computer system for use by healthcare service providers in selecting diagnosis code/procedure code pairs that are eligible for reimbursement under a set of medical necessity policy rules, the system comprising:
A. a means for receiving medical necessity policy rules information including a subset of the universe of diagnosis codes for a given code set of diagnosis codes, a subset of the universe of procedure codes for a given code set of procedure codes, and a set of medical necessity policy rules;
B. a means for displaying the subset of diagnosis codes and corresponding descriptions;
C. a means for displaying the subset of procedure codes and corresponding descriptions; and
D. a means of displaying a set of diagnosis codes for a given procedure code P1 where each of the displayed diagnosis codes could be combined with the procedure code P1 to form a diagnosis code/procedure code pair eligible for reimbursement under the set of medical necessity policy rules.

11. The mobile computer system of claim 10 further comprising a means of displaying a set of procedure codes for a given diagnosis code D1 where each of the displayed procedure codes could be combined with the diagnosis code D1 to form a diagnosis code/procedure code pair eligible for reimbursement under the set of medical necessity policy rules.

12. The mobile computer system of claim 10 further comprising a means for creating an order for medical services through electronic integration with an electronic medical record system, the order containing the procedure code P1 and a diagnosis code selected from the displayed set of diagnosis codes for the given procedure code P1.

13. A process for creating a bill to a third party payor for payment for medical procedure performed on medical patient M1, the process comprising:
Examining medical patient M1;
Formulating an initial diagnosis with diagnosis code D1 for medical patient M1 during the examination of medical patient M1;
Using a handheld code-checking device to present a set of procedure codes eligible for reimbursement for a patient with diagnosis D1 under the set of medical necessity policy rules for the third party payor that will be billed for medical services provided to medical patient M1;
Selecting a procedure code P1 from the list of codes eligible for reimbursement;
Ordering that procedure code P1 be performed for medical patient M1 with expectation that the third party payor will pay for the performance of procedure code P1 on medical patient M1 with diagnosis code D1 based on the representation of the third party payor medical necessity policy rules contained in the handheld code-checking device;
Performing procedure code P1 on medical patient M1;
Documenting the performance of procedure code P1 on medical patient M1; and then
Billing the third party payor the performance of procedure code P1 on medical patient M1 with diagnosis code D1.
